(19) United States
(12) Patent Application Publication
(10) Pub. No.: US 2018/0124497 A1
(43) Pub. Date: May 3, 2018

(54) Augmented Reality Sharing for Wearable Devices

(71) Applicant: BRAGI GmbH, München (DE)

(72) Inventor: Peter Vincent Boesen, München (DE)

(73) Assignee: BRAGI GmbH, München (DE)

(21) Appl. No.: 15/793,324

(22) Filed: Oct. 25, 2017

Related U.S. Application Data
(60) Provisional application No. 62/415,033, filed on Oct. 31, 2016.

(51) Int. Cl. H04R 1/10; H04L 29/08; G02B 27/00; H04W 4/00

(52) U.S. Cl. CPC H04R 1/1091; H04L 67/22; H04R 2420/07; H04W 4/005; G02B 27/0093

(57) ABSTRACT

A system, method, and wireless earpieces for communicating augmented reality content. A sharing request for the augmented reality content is received through wireless earpieces. One or more receiving devices are identified. The augmented reality content is formatted for communication. The augmented reality content is communicated to the one or more receiving devices.

### PRIORITY STATEMENT

This application claims priority to U.S. Provisional Patent Application 62/415,033, filed on Oct. 31, 2016, and entitled Augmented Reality Sharing for Wearable Devices, hereby incorporated by reference in its entirety.

### BACKGROUND

### I. Field of the Disclosure

The illustrative embodiments relate to conferencing communications within augmented reality, virtual reality, and telepresence systems. More specifically, but not exclusively, the illustrative embodiments relate to interactions between one or more users, wireless earpieces, and enhanced communications systems.

II. Description of the Art

The growth of augmented reality systems that utilize virtual reality and augmented reality technologies is growing nearly exponentially. This growth is fostered by the decreasing size of microprocessors, circuity boards, projectors, displays, chips, and other components. Various virtual reality and augmented reality systems, such as headsets, are decreasing in size and increasing in functionality, but are still bulky and heavy. The additional mass of headphone units worn by a user may further unbalance motion of the user's head when utilizing a virtual reality system. Tracking the locations, positions, motion, acceleration, and orientation, such as a number of users positioned within a conferencing room relative to each other, may be difficult. In addition, some existing systems and devices, such as external microphones, have significant latency when sending and receiving audio communications.

### SUMMARY OF THE DISCLOSURE

One embodiment provides a system, method, and wireless earpieces for communicating augmented reality content. A sharing request for the augmented reality content is received through wireless earpieces. One or more receiving devices are identified. The augmented reality content is formatted for communication. The augmented reality content is communicated to the one or more receiving devices. Another embodiment provides wireless earpieces. The wireless earpieces include a processor for executing a set of instructions and a memory for storing the set of instructions. The set of instructions are executed to perform the method described above.

Yet another embodiment provides an augmented reality system. The augmented reality system may include augmented reality glasses displaying augmented reality content to a user. The augmented reality system may further include wireless earpieces including sensors that detect the position and an orientation of the head of the user and one or more microphones. The wireless earpieces receive a sharing request for the augmented reality content through wireless earpieces, identify one or more receiving devices, format the augmented reality content for communication, and communicate the augmented reality content to the one or more receiving devices.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of an augmented reality system in accordance with an illustrative embodiment;

FIG. 2 is a block diagram of wireless earpieces and augmented reality glasses in accordance with an illustrative embodiment; and

FIG. 3 is a flowchart of a process for sharing augmented reality content in accordance with an illustrative embodiment; and

FIG. 4 depicts a computing system in accordance with an illustrative embodiment.

### DETAILED DESCRIPTION OF THE DISCLOSURE

The illustrative embodiments provide a system and method for conferencing communications utilizing wireless earpieces. The wireless earpieces may communicate with a conferencing system, augmented reality system, or virtual reality system as a separate or joint system. The illustrative embodiments may be utilized to allow one or more remote users to participate in a conference utilizing augmented or virtual reality. The illustrative embodiments may utilize augmented or virtual reality to present the remote user(s) as if present at a location of the conference.

In one embodiment, the location and orientation of distinct users may be determined utilizing information from the wireless earpieces that may be paired with or physically connected to glasses or headsets. For example, any number of wireless earpieces utilized within the system may determine the spatial location, distances, orientation, volume, voice characteristics, and other applicable information of the users, furniture, and equipment within a conferencing area. The conferencing area may represent any number of rooms, vehicles, open spaces, or other locations where a conference may be implemented or held.

In one embodiment, the various users may be positioned within the conferencing area and displayed to each other for enabling effective, real-time, and lifelike interactions. The three-dimensional determination of direction, location, orientation, and volume of sound and audio within the conferencing area may be measured, analyzed, and utilized to display and communicate applicable images, video, audio, data, and other information to the user. In one embodiment, a camera system proximate a remote user may capture video or images of the user for utilization with the illustrative embodiments. A camera system may also be integrated as part of the conference area for capturing video and images of the user so that all of the users may be shown an image or video of each other.

The wireless earpieces may communicate with the augmented reality system, such as a virtual reality or augmented reality headset, glasses, display, holographic display, or projector (hereinafter “glasses”), in real-time (or near real-time). The glasses may communicate with the wireless earpieces wirelessly or utilizing a wired connection. In one embodiment, the glasses may be coupled to the wireless earpieces utilizing magnetic connectors. For example, wires extending from the glasses may magnetically couple and utilize induction communications and power transfer to power the wireless earpieces. In another example, ports and interfaces, such as micro-USB connectors may be utilized to connect the wireless earpieces to the glasses. In another example, a wireless protocol, standard, connection, or link, such as Bluetooth may be utilized.

The illustrative embodiments may be utilized for entertainment, scientific, educational, or commercial applications. Glasses including virtual reality or augmented reality headsets, heads-up displays, helmets, or other vision or display systems, such as those produced by Google, HTC, Samsung, oculus, Sony, Microsoft, and so forth, may present any number of two-dimensional or three-dimensional visualizations to the user. The illustrative embodiments minimize the existing mass problems with bulky over-ear headphones or other audio systems. As a result, the characteristics of angular momentum associated with the user's head are not increased significantly decreasing the effects of torque and neck and head strain that may be associated with such virtual reality systems.

In addition, user participating in a conference may not be required to utilize microphones that sit on a desk or are externally positioned from the user decreasing the effectiveness of the microphone. For example, many remotely positioned microphones do not have any additional sensors and their remote position may increase latency and delay when sensing various audio inputs from the user, environment, or so forth. The illustrative embodiments allow a conference system to incorporate position, orientation, movement, and acceleration (e.g., angular, linear, etc.) as part of the user input, responses, and feedback. As a result, the audio and visual information presented to the user may be adjusted in response to audio input received from the user as well as the corresponding user information including position, orientation, movement, and acceleration.

The wireless earpieces may include any number of sensors that may communicate with the sensors, systems and components of the augmented reality system to further enhance the user's experience. In one embodiment, the sensors of the wireless earpieces may include touch sensors, proximity sensors, accelerometers, gyroscopes, magnetometers, optical sensors, pulse oximeters, GPS chips, thermometers, and so forth. The data acquired by the sensors may be utilized to determine the user's condition, characteristics, position, orientation, movement, acceleration, location, or so forth. As a result, the data may be utilized to enhance the users experience within the video conference. In addition, the sensors provide data that enhances sensor measurements of the glasses. The precise determination of the user's location, orientation, movement, and position may also be utilized to provide more accurate three-dimensional spatial video and sound imaging for the user. For example, allowable or communicated content, actions, and processes implemented by the glasses may vary based on the applicable user information In addition, the sensors may be utilized to sense any number of biometric readings or information, such as heart rate, respiratory rate, blood, or skin physiology, or other biometric data. This information may be utilized to determine whether the user is stressed, fatigued, or so forth. In one example, the video conference may be controlled based on user information. Besides being connected to or integrated with the glasses, the wireless earpieces may be utilized to make and receive communications (e.g., telephone calls, transcribed text messages, audio/tactile alerts, etc.), play music, filter or block sound, amplify sounds, or so forth.

The wireless earpieces may be utilized for daily activities, such as gaming, business communications, exercising, phone calls, travel, and so forth. The wireless earpieces may then also serve a dual-purpose by integrating as an audio portion of an augmented reality system. As a result, more expensive audio components are not required thereby reducing the cost and weight of the augmented reality system. The sensor and audio inputs sensed by the wireless earpieces are processed with minimal latency due to positions of the microphones within the wireless earpieces at the lateral and medial segments as positioned within the ears of the user. The microphone and other sensor inputs provide enhanced input modality to the conferencing programs and processes implemented by the wireless earpieces.

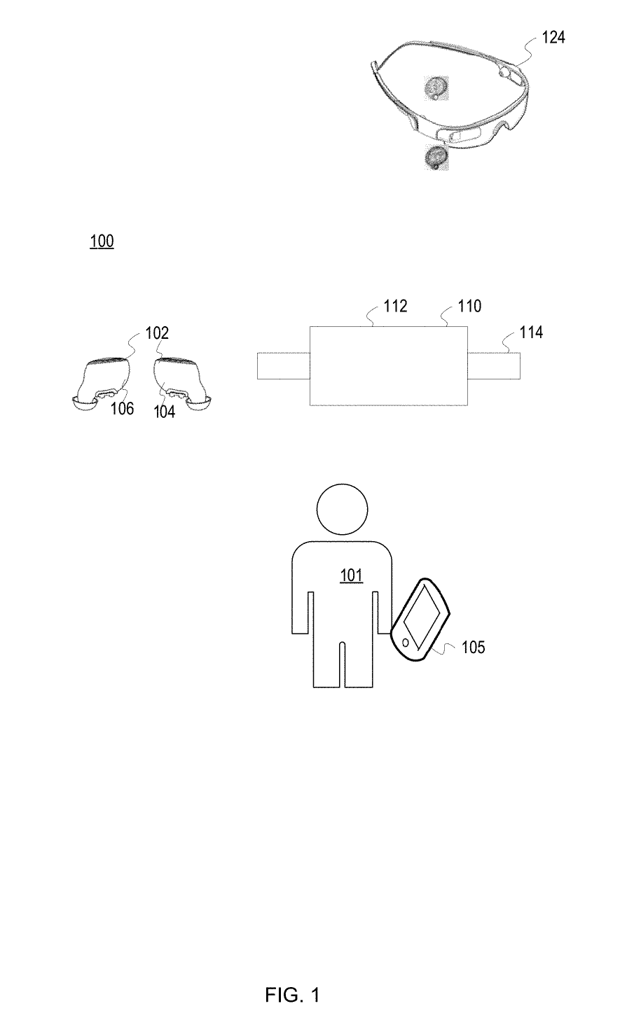

FIG. 1 is a pictorial representation of an augmented reality system 100 in accordance with an illustrative embodiment. The augmented reality system 100 may include any number of devices, components, systems, and participants. In one embodiment, the augmented reality system 100, may include a user 101, wireless earpieces 102 including a right earpiece 104 and a left earpiece 106, wireless headset 110 including a visor 112, and a strap 114. The wireless earpieces 102 may be referred to as a pair or set (wireless earpieces 102) or singularly (wireless earpiece 102, right earpiece 104, left earpiece 106). The augmented reality glasses 124 are shown as an alternative to the wireless headset 110 and the various description, components, and functionality are similarly applicable to the augmented reality glasses 124.

The description may also refer to components and functionality of each of the wireless earpieces 102 collectively or individually. In one embodiment, the wireless earpieces 102 include a left earpiece and a right earpiece configured to fit into ears of a user 101. The wireless earpieces 102 are shown separately from their positioning within the ears of the user 101 for purposes of simplicity. In one embodiment, the augmented reality system 100 may be utilized for conference communications. The augmented reality system 100 may also be utilized for training, media, gaming, work, simulations, or so forth.

The wireless earpieces 102 are configured to play audio associated with conference and visual content presented by the wireless headset 110. The wireless earpieces 102 may be configured to play music or audio, receive and make phone calls or other communications, determine ambient environmental readings (e.g., temperature, altitude, location, speed, heading, etc.), read user biometrics and actions (e.g., heart rate, motion, sleep, blood oxygenation, calories burned, etc.), and communicate content audibly, tactilely, and visually.

The wireless earpieces 102 may include interchangeable parts that may be adapted to fit the needs of the user 101 (e.g., size and shape of the user's ear). For example, sleeves of the wireless earpieces 102 that fit into the ear of the user 101 may be interchangeable to find a suitable shape and configuration. The wireless earpieces 102 may include a number of sensors and input devices including, but not limited to, pulse oximeters, microphones, pulse rate monitors, thermometers, touch sensors, accelerometers, gyroscopes, optical sensors, global positioning sensors, and so forth. Sensors, components, or sub-systems of the wireless headset 110 may also be configured to wirelessly communicate with the wireless earpieces 102.

The wireless headset 110 replicates or displays an environment (e.g., conference room, home office, etc.) simulating physical presence of users in the real world or imagined worlds and lets the users interact in that environment. The augmented reality system 100 may be utilized to function in an augmented reality, virtual reality, projection, display, or holographic environment (e.g., including the associated signals, displays, equipment, etc.). The wireless headset 110 or the augmented reality glasses 124 may generate a live direct or indirect view of a physical, real-world environment, such as a conference room, where computer-generated sensory input, such as sound, video, graphics, data, or other information is added or supplemented to enhance the view. Virtual reality may also be referred to as immersive multimedia and may be utilized to create sensory experiences which may include sight, hearing, touch, smell, and taste. The wireless headset 110 may be powered by a power plug, battery, or other connection (e.g., USB connection to a computing or gaming device). The wireless headset 110 may also communicate (send and receive) data utilizing a wired or wireless connection to any number of computing, communications, or entertainment devices.

The visor 112 may be utilized to display visual and graphical information to the user 101. The visor 112 may include one or more displays (e.g., liquid crystal displays, light emitting diode (LED) displays, organic LED, etc.) or projectors (direct, indirect, or refractive) for displaying information to the eyes of the user 101. Although not shown, the wireless headset 110 may also include touch screens, EEG interfaces, tactile interfaces, vibration components, ultrasonic or infrared interfaces, smell interfaces, or tasting interfaces for enhancing the experience of the user 101. The size and shape of the wireless headset 110, visor 112, and the strap 114 may vary by make, model, manufacturer as well as user configuration of the wireless headset 110, such as those produced by Google, HTC, Sony, Oculus, Epson, Samsung, LG, Microsoft, Durovis, Valve, Avegant, and others. In one embodiment, the visor 110 may be transparent allowing the user to interact and function in the real-world while still communicating virtual information. The visor 110 may also transition between transparent and opaque (or a viewing mode) for displaying applicable content. For example, electronic glass utilizing a current and specialized layers of materials (e.g., gasses, coatings, etc.) may be utilized to control the visor 110. The wireless earpieces 102, visor 112, wireless headset 110 may be configured for augmented reality functionality, processes, displays, and so forth as are herein described.

The strap 114 extends between sides of the visor 112 and is configured to secure the wireless headset 110 to the head of the user 101. The strap 114 may be formed of any number of materials, such as cotton, polyester, nylon, rubber, plastic, or so forth. The strap 114 may include buckles, loops, or other adjustment mechanisms for fitting the wireless headset 110 to the head of the user 101. The strap 114 may be flexible to comfortably fit to the head of the user 101. The strap 114 may also incorporate biometric or environmental sensors, such as EEG sensors or transmitters, for interfacing with the user. The strap 114 may also include a battery, solar cells, piezo electric components, wires, busses, or so forth for powering the visor 112 or communicating data or information to other components of the wireless headset 110. The strap 114 may also be replaced by any number of earpieces, frames, support pieces, or so forth.

In another embodiment, the connectors may be integrated with components or a frame of the wireless headset 110. Some virtual reality headsets are much more helmet-like or include various structural components (e.g., straps, arms, extensions, etc.) for securing the wireless headset 110 to the head of the user during both regular and vigorous usage.

The wireless earpieces 102 communicate with the headset 110 utilizing the connectors or wirelessly. Where used, the connectors may represent wires, cables, busses, traces, or other connectors. The connectors may be coated with rubber, plastic, or other sheathing materials to protect the connectors as well as the user (e.g., metal slivers, shock, etc. In one embodiment, the connectors may be flexible allowing the wireless headset 110 and the wireless earpieces 102 to be best fitted to the anatomy of the user 101. In another embodiment, the connectors may represent strictly physical connectors to ensure that the wireless earpieces 102 are not dropped, lost, or damaged during utilization. For example, the connectors may represent a lanyard or strap.

In another embodiment, the wireless earpieces 102 may communicate utilizing any number of wireless connections, standards, or protocols (e.g., near field communications, Bluetooth, Wi-Fi, ANT+, proprietary, etc.). The wireless headset 110 may locally or remotely implement and utilize any number of operating systems, kernels, instructions, or applications that may make use of the sensor data and other information measured by the wireless earpieces 102. For example, the wireless headset 110 may utilize any number of android, iOS, Windows, open platform, or other systems. Similarly, the wireless headset 110 may include a number of applications that utilize the biometric data from the wireless earpieces 102 to display applicable information and data. For example, the biometric information (including, high, low, average, or other values) may be processed by the wireless earpieces 102 or the wireless headset 110 to display heart rate, blood oxygenation, altitude, speed, distance traveled, calories burned, or other applicable information.

In one embodiment, a wireless device 105 may include any number of sensors (e.g., similar to those described with regard to the wireless earpieces 102) that may be utilized to augment the sensor readings of the wireless earpieces 102. For example, a microphone of the wireless device 106 may determine an amount and type of ambient noise. The noise may be analyzed and utilized to filter the sensor readings made by the wireless earpieces 102 to maximize the accuracy and relevance of the sensor measurements of the wireless earpieces 102. Filtering, tuning, and adaptation for the sensor measurements may be made for signal noise, electronic noise, or acoustic noise, all of which are applicable in the communication system 100. The wireless device 105 may also generate augmented reality content that may be utilized by the wireless earpieces 102

The cameras of the wireless device 105 may also be utilized to position the user 101 within the environment of the augmented reality system 100. For example, the cameras of the wireless device 105 may determine location, position, and orientation of the user 101 as well as the user's environment to provide augmented reality content. In other embodiments, the augmented reality system may include a number/array of microphones and cameras for detecting noises, audio, and video associated with the user 101 and the augmented reality system 100. In addition, the augmented reality system 100 may utilize any number of other devices, components, systems, or equipment.

The wireless headset 110 may also include accelerometers, gyroscopes, magnetometers, radar sensors, and so forth that determine the location, position, and orientation of the user 101 within the augmented reality system 100 which may represent a number of indoor or outdoor environments. Sensor measurements made by either the wireless earpieces 102, wireless device 105, or sensor devices of the user 101 may be communicated with one another in the communication system 100. The wireless device 105 is representative of any number of personal computing, communications, exercise, medical, or entertainment devices that may communicate with the wireless earpieces 102.

With respect to the wireless earpieces 102, sensor measurements may refer to measurements made by one or both of the wireless earpieces 102. For example, the wireless earpieces 102 may determine that the sensor signal for the microphone of the right wireless earpiece is very noisy and as a result, may utilize the microphone ratings from the microphone of the left wireless earpiece as the primary reading. The wireless earpieces 102 may also switch back and forth between microphones of the left earpiece 106 and the right earpiece 104 in response to varying noise for both of the wireless earpieces 102. As a result, the clearest sensor signal may be utilized at any given time. In one embodiment, the wireless earpieces 102 may switch sensor measurements in response to the sensor measurements exceeding or dropping below a specified threshold.

The user 102 may also be wearing or carrying any number of sensor-enabled devices, such as heart rate monitors, pacemakers, smart glasses, smart watches or bracelets (e.g., Apple watch, Fitbit, etc.), or other sensory devices that may be worn, attached to, or integrated with the user 102. The data and information from the external sensor devices may be communicated to the wireless earpieces 102. In another embodiment, the data and information from the external sensor devices may be utilized to perform additional processing of the information sent from the wireless earpieces 102 to the wireless device 106.

The sensors of the wireless earpieces 102 may also be positioned at enantiomeric locations. For example, a number of colored light emitting diodes may be positioned to provide variable data and information, such as heart rate, respiratory rate, and so forth. The data gathered by the LED arrays may be sampled and used alone or in aggregate with other sensors. As a result, sensor readings may be enhanced and strengthened with additional data.

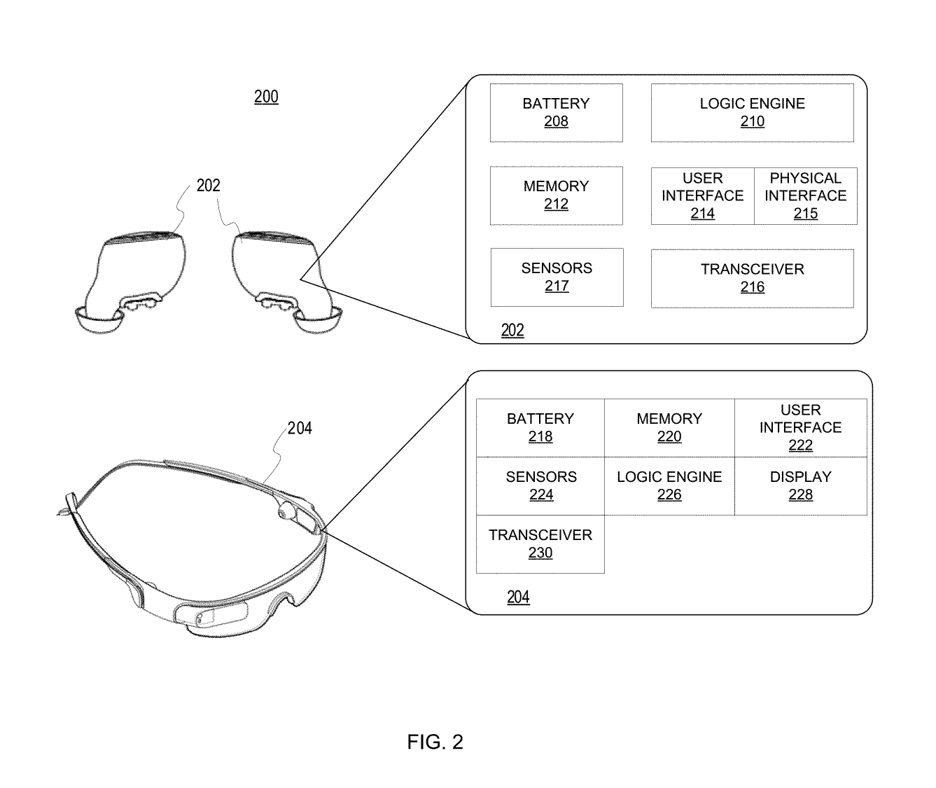

FIG. 2 is a block diagram of an augmented reality system 200 in accordance with an illustrative embodiment. In one embodiment, the augmented reality system 200 may include wireless earpieces 202 (described collectively rather than individually) and augmented reality glasses 204. The augmented reality glasses 204 may include or be connected to an augmented reality computing or communications system, such as a gaming device, server, personal computing device, or so forth. In one embodiment, the wireless earpieces 202 may enhance communications and functionality of the augmented reality system 200. For example, the wireless earpieces 202 may provide high quality audio that compliments the virtual environments provided by the augmented reality glasses 204. In addition, the wireless earpieces 202 may include sensors 217 that detect the location, position, orientation, movement, and acceleration of the user for providing feedback to the augmented reality glasses 204. The sensors 217 may augment the measurements taken by the augmented reality glasses 204

As shown, the wireless earpieces 202 may be physically or wirelessly linked to the augmented reality glasses 204. User input and commands may be received from either the wireless earpieces 202 or the augmented reality glasses 204 for implementation on either of the devices of the augmented reality system 200 (or other externally connected devices). As previously noted, the wireless earpieces 102 may be referred to or described herein as a pair (wireless earpieces) or singularly (wireless earpiece). The description may also refer to components and functionality of each of the wireless earpieces 202 collectively or individually.

The wireless earpieces 202 play the audio corresponding to the augmented reality content displayed by the augmented reality glasses 204. In one embodiment, the wireless earpieces 202 may play the sounds and audio received from the augmented reality glasses 204 based on the sensed location, position, orientation, speed, and acceleration of the user as measured by the sensors 217. For example, if the user's head is inclined as if he is riding or simulating riding a bicycle, the corresponding audio may be played to simulate actually riding a bike and the way sounds and noises may strike the ears of the user. In another example, the audio and sounds may be played as if the user's head was turned a particular direction. For example, the sounds and audio may be more prominent in the left ear rather than the right ear based on the position and orientation of the user simulated by the wireless earpieces 202. In addition, the wireless earpieces 202 may provide additional biometric and user data that may be further utilized by the augmented reality glasses 204 or connected computing, entertainment, or communications devices.

In some embodiments, the augmented reality glasses 204 may act as a logging tool for receiving information, data, or measurements made by the wireless earpieces 202. For example, the augmented reality glasses 204 may be worn by the user to download data from the wireless earpieces in real-time. As a result, the augmented reality glasses 204 may be utilized to store, display, and synchronize data to the wireless earpieces 202. For example, the augmented reality glasses 204 may display pulse, oxygenation, distance, calories burned, and so forth as measured by the wireless earpieces 202. The wireless earpieces 202 and the augmented reality glasses 204 may have any number of electrical configurations, shapes, and colors and may include various circuitry, connections, and other components. The data logged by the augmented reality glasses 204 may be shared with other users, devices, or systems based on a user request or user preferences. For example, augmented reality glasses 204 may show pulse, cadence, and speed to multiple users that are exercising in different locations (e.g., jogging, biking, etc.), but that want to simulate training or competing together or against each other. Any number of biometrics, information, or other data specified by the user may be shared as part of the augmented reality content.

In one embodiment, the wireless earpieces 202 may include a battery 208, a logic engine 210, a memory 212, user interface 214, physical interface 215, a transceiver 216, and sensors 212. Similar components within the augmented reality glasses 204 may be similarly structured to provide analogous functionality, features, and processes. Likewise, the augmented reality glasses 204 may have a battery 218, a memory 220, a user interface 222, sensors 224, a logic engine 226, a display 228, and a transceiver 230. The battery 208 is a power storage device configured to power the wireless earpieces 202. Likewise, the battery 218 is a power storage device configured to power the augmented reality glasses 204. The battery 218 may represent a converter, inverter, port, plug, or interface for receiving power and/or communications from an augmented reality processing system (not shown). In other embodiments, the batteries 208 and 218 may represent a fuel cell, thermal electric generator, piezo electric charger, solar charger, ultra-capacitor, or other existing or developing power storage technologies.

The logic engine 210 is the logic that controls the operation and functionality of the wireless earpieces 202. The logic engine 210 may include circuitry, chips, and other digital logic. The logic engine 210 may also include programs, scripts, and instructions that may be implemented to operate the logic engine 210. The logic engine 210 may represent hardware, software, firmware, or any combination thereof. In one embodiment, the logic engine 210 may include one or more processors. The logic engine 210 may also represent an application specific integrated circuit (ASIC) or field programmable gate array (FPGA). The logic engine 210 may utilize information from the sensors 212 to determine the biometric information, data, and readings of the user. The logic engine 210 may utilize this information and other criteria to inform the user of the biometrics (e.g., audibly, through an application of a connected device, tactilely, etc.). The logic engine 210 may also determine the location, orientation, position, speed, and acceleration of the user utilizing the sensors 217. For example, the sensors 217 may include accelerometers, gyroscopes, optical sensors, or miniaturized radar that may be utilized to determine associated user information. The logic engine 210 may also control how augmented reality content is both sent and received from the transceiver 216 of the wireless earpieces 202.

In one embodiment, the logic engines 210 and 226 may integrated audio and video content as well as user biometrics to generate augmented reality content. The logic engines 210 and 226 may also control how the augmented reality content is shared with other augmented reality systems (e.g., secondary wireless earpieces and glasses). In one embodiment, the logic engines 210 and 226 may control execution of one or more applications, modules, operating systems, or software modules utilized to control and manage sharing of augmented reality content.

The logic engine 210 may also process user input to determine commands implemented by the wireless earpieces 202 or sent to the wireless earpieces 204 through the transceiver 216. The user input may be determined by the sensors 217 to determine specific actions to be taken. For example, the input may specify that augmented reality content captured, generated, or compiled by the wireless earpieces 202 and the augmented reality glasses 204 are to be shared with a group including three designated augmented reality systems. In one embodiment, the logic engine 210 may implement a macro allowing the user to associate user input as sensed by the sensors 217 with commands. For example, in response to a designated user gesture sensed by the wireless earpieces, augmented reality content may be generated and/or shared with other systems.

In one embodiment, a processor included in the logic engine 210 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements of a smart case.

The memory 212 is a hardware element, device, or recording media configured to store data for subsequent retrieval or access at a later time. The memory 212 may be or include static and/or dynamic memory. The memory 212 may include one or more of a hard disk, random access memory, cache, removable media drive, mass storage, or configuration suitable as storage for data, instructions, and information. In one embodiment, the memory 212 and the logic engine 210 may be integrated. The memory may use any type of volatile or non-volatile storage techniques and mediums. The memory 212 may store information related to the status of a user, wireless earpieces 202, augmented reality glasses 204, and other peripherals, such as a wireless device, smart case for the wireless earpieces 202, smart watch, and so forth. In one embodiment, the memory 212 may display instructions or programs for controlling the user interface 714 including one or more LEDs or other light emitting components, speakers, tactile generators (e.g., vibrator), and so forth. The memory 212 may also store the user input information associated with each command. The memory 212 may also store augmented reality content for subsequent communication to one or more other users. The memory 212 may store user preferences including parameters, settings, factors, user information, and so forth that may be utilized to implement automatic or manual sharing of augmented reality content.

The transceiver 216 is a component comprising both a transmitter and receiver which may be combined and share common circuitry on a single housing. The transceiver 216 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.) or other suitable radio frequency standards, networks, protocols, or communications. The transceiver 216 may also be a dual or hybrid transceiver that supports a number of different communications. For example, the transceiver 216 may communicate with the augmented reality glasses 204 or other systems utilizing wired interfaces (e.g., wires, traces, etc.), NFMI, NFC, or Bluetooth communications.

The components of the wireless earpieces 202 (or the augmented reality system 200) may be electrically connected utilizing any number of wires, contact points, leads, busses, wireless interfaces, or so forth. In addition, the wireless earpieces 202 may include any number of computing and communications components, devices or elements which may include busses, motherboards, circuits, chips, sensors, ports, interfaces, cards, converters, adapters, connections, transceivers, displays, antennas, and other similar components.

The physical interface 215 is hardware interface of the wireless earpieces 202 for connecting and communicating with the augmented reality glasses 204 or other electrical components. The physical interface 215 may include any number of pins, arms, or connectors for electrically interfacing with the contacts or other interface components of external devices or other charging or synchronization devices. For example, the physical interface 215 may be a micro USB port. In one embodiment, the physical interface 215 is a magnetic interface that automatically couples to contacts or an interface of the augmented reality glasses 204. In another embodiment, the physical interface 215 may include a wireless inductor for charging the wireless earpieces 202 without a physical connection to a charging device.

The user interface 214 is a hardware interface for receiving commands, instructions, or input through the touch (haptics) of the user, voice commands, or predefined motions. The user interface 214 may be utilized to control the other functions of the wireless earpieces 202. Although not shown, the one or more speakers of the user interface 214 may include a number of speaker components (e.g., signal generators, amplifiers, drivers, and other circuitry) configured to generate sounds waves at distinct frequency ranges (e.g., bass, woofer, tweeter, midrange, etc.) or to vibrate at specified frequencies to be perceived by the user as sound waves.

The speakers may also generate sound waves to provide three-dimensional stereo sound to the user. All or portions of the speakers may be activated or directed within the wireless earpieces 202 to generate various effects. The speakers may quickly respond to content sent from the augmented reality glasses 204 or other portions of the augmented reality system 200 to add to the realistic effects and processing experienced by the user. The user interface 214 may include an LED array, one or more touch sensitive buttons or screens, portions or sensors, a miniature screen or display, or other input/output components. The user interface 214 may be controlled by the user or based on commands received from the augmented reality glasses 204 or a linked wireless device. The user interface 214 may also include traditional software interfaces, such as a graphical user interface or applications that may be executed by the logic engine 210 for communication by the user interface 214. For example, the speakers may simulate users, devices, or sounds spatially positioned relative to the user wearing the wireless earpieces 202. As a result, a person or animal that appears to be forward and to the left of the user will also sound like they are so positioned based on sounds received and played by the wireless earpieces 202 relative to the communicated augmented reality content.

User input or feedback to share augmented reality content may be received or detected utilizing any number of methods, components, and processes. In one embodiment, the user may provide feedback by tapping the user interface 214 once, twice, three times, or any number of times. Similarly, a swiping motion may be utilized across or in front of the user interface 214 (e.g., the exterior surface of the wireless earpieces 202, proximate the exterior surface for optical sensors) etc.) to implement a predefined action. Swiping motions in any number of directions may be associated with specific activities, such as share augmented reality content, play music, pause, fast forward, rewind, activate a digital assistant (e.g., Siri, Cortana, smart assistant, etc.). The swiping motions may also be utilized to control actions and functionality of the augmented reality glasses 204 or other external devices (e.g., smart television, camera array, smart watch, etc.). The user may also provide user input by moving her head in a particular direction or motion or based on the user's position or location. For example, the user may utilize voice commands, head gestures, or touch commands to change the content displayed by the augmented reality glasses 204. The audio and video input from the user and received from the augmented reality system 200 may be enhanced to accurately determine position, location, orientation, motion and acceleration of the user/user's head within a three-dimensional space. As a result, audio or sound effects, such as loudness, masking, pitch (including changes, such as the Doppler effect), timbre, localization, and other user affects heard and perceived by the user.

The sensors 217 may include pulse oximeters, accelerometers, gyroscopes, magnetometers, inertial sensors, photo detectors, microphones (e.g., ear-bone or bone conduction microphones, exterior microphones, etc.) miniature cameras, and other similar instruments for detecting location, orientation, motion, and so forth. The sensors 217 may also be utilized to gather optical images, data, and measurements and determine an acoustic noise level, electronic noise in the environment, ambient conditions, and so forth.

The sensors 217 may provide measurements or data that may be utilized to filter or select images for display by the augmented reality glasses 204. For example, motion or sound detected on the left side of the user may be utilized to command the smart glasses to display camera images from the left side of the user. Motion or sound may be utilized, however, any number of triggers may be utilized to send commands to the augmented reality glasses 204. The sensors 217 may sense the user input, commands, or feedback utilized to share augmented reality content or perform any number of other steps, processes, or so forth.

The microphones of the sensors 217 may immediately receive and process audio signals and sounds from the user thereby minimizing latency and delay. As a result, the augmented reality system 200 may perform effectively for real-time scenarios, simulations, games, communications, or so forth. The microphones may sense verbal feedback from the user as well as audio input associated with the user and environment (e.g., foot falls, breaths, grunts, wind, etc.) to provide relevant information to the augmented reality system 200. The microphones may also process the audio content integrated with the augmented reality content.

The augmented reality glasses 204 may include components similar in structure and functionality to those shown for the wireless earpieces 202 including a battery 218, a memory 220, a user interface 222, sensors 224, a logic engine 226, a display 228, and transceiver 230. The augmented reality glasses 204 may include the logic engine 226 for executing and implementing the processes and functions as are herein described. The battery 218 of the augmented reality glasses 204 may be integrated into the frames of the augmented reality glasses 204 and may have extra capacity which may be utilized to charge the wireless earpieces 202. For example, the wireless earpieces 202 may be magnetically coupled or connected to the augmented reality glasses 204 so that the battery 218 may be charged. All or a portion of the logic engine 226, sensors, user interface 222, sensors 224, display, and transceiver 230 may be integrated in the frame and/or lenses of the augmented reality glasses 204.

The user interface 222 of the augmented reality glasses 204 may include a touch interface or display for indicating the status of the augmented reality glasses 204. For example, an external LED light may indicate the battery status of the augmented reality glasses 204 as well as the connected wireless earpieces 202, connection status (e.g., linked to the wireless earpieces 202, wireless device, etc.), download/synchronization status (e.g., synchronizing, complete, last synchronization, etc.), or other similar information. The user interface 222 may also be utilized to receive commands. For example, the user interface 222 may include touch sensors, soft buttons, buttons, switches, or so forth. The user interface 222 may receive user input to share the augmented reality content in real-time, at a subsequent time, or based on designated criteria.

The display 228 may be integrated into the lenses of the augmented reality glasses 204 or represent one or more projectors that may project content directly or reflectively to the eyes of the user. For example, the display 228 may represent a transparent organic light emitting diode lens that is see through and may be utilized to display content. Projectors of the display 228 may utilize any number of wavelengths or light sources to display data, images, or other content to the user. The augmented reality glasses 204 may also be utilized for augmented reality displays. The augmented reality glasses 204 may take any number of forms including regular glasses, disposable headsets, and so forth. The augmented reality glasses 204 may be very small and unobtrusive. In one embodiment, the augmented reality glasses 204 may be integrated in smart contact lenses that communicate with the wireless earpieces 202 as described herein. The display 228 may also include optical or tracking sensors configured to receive user feedback from the user through the motion or activity of her eyes in order to implement any number of predefined actions, commands, inputs, or processes.

An LED array of the user interface 222 may also be utilized for display actions. For example, the LED array may indicate when augmented reality content is being streamed from the wireless earpieces 202 and the augmented reality glasses 204 to other similar systems, devices, components, or equipment. For example, an LED may be activated in response to someone or something being in the user's blind spot while riding a bicycle. In another embodiment, device status indications may emanate from the LED array of the wireless earpieces 202 themselves, triggered for display by the user interface 222 of the augmented reality glasses 204. The battery 218 may itself be charged through a physical interface of the user interface 222. The physical interface may be integrated with the user interface 222 or may be a separate interface. For example, the user interface 222 may also include a hardware interface (e.g., port, connector, etc.) for connecting the augmented reality glasses 204 to a power supply or another electronic device. The user interface 222 may be utilized for charging as well as communications with externally connected devices. For example, the user interface 222 may represent a mini-USB, micro-USB or other similar miniature standard connector. In another embodiment, a wireless inductive charging system may be utilized to initially replenish power to the wireless earpieces 202. The augmented reality glasses 204 may also be charged utilizing inductive charging.

In another embodiment, the augmented reality glasses 204 may also include sensors for detecting the location, orientation, and proximity of the wireless earpieces 202. For example, the augmented reality glasses 204 may include optical sensors or cameras for capturing images and other content around the periphery of the user (e.g., front, sides, behind, etc.). The augmented reality glasses 204 may detect any number of wavelengths and spectra to provide distinct images, enhancement, data, and content to the user. The augmented reality glasses 204 may also include an LED array, galvanic linkage or other touch sensors, battery, solar charger, actuators or vibrators, one or more touch screens or displays, an NFC chip, or other components. The sensors 224 may include integrated sensors that are part of the augmented reality glasses 204 as well as external sensors that communicate with the augmented reality glasses 204. For example, the sensors 224 may also measure the position, location, orientation, motion, and acceleration of other portions of the user's body including arms, legs, torso, and so forth.

As originally packaged, the wireless earpieces 202 and the augmented reality glasses 204 may include peripheral devices such as charging cords, power adapters, inductive charging adapters, solar cells, batteries, lanyards, additional light arrays, speakers, smart case covers, transceivers (e.g., Wi-Fi, cellular, etc.), or so forth.

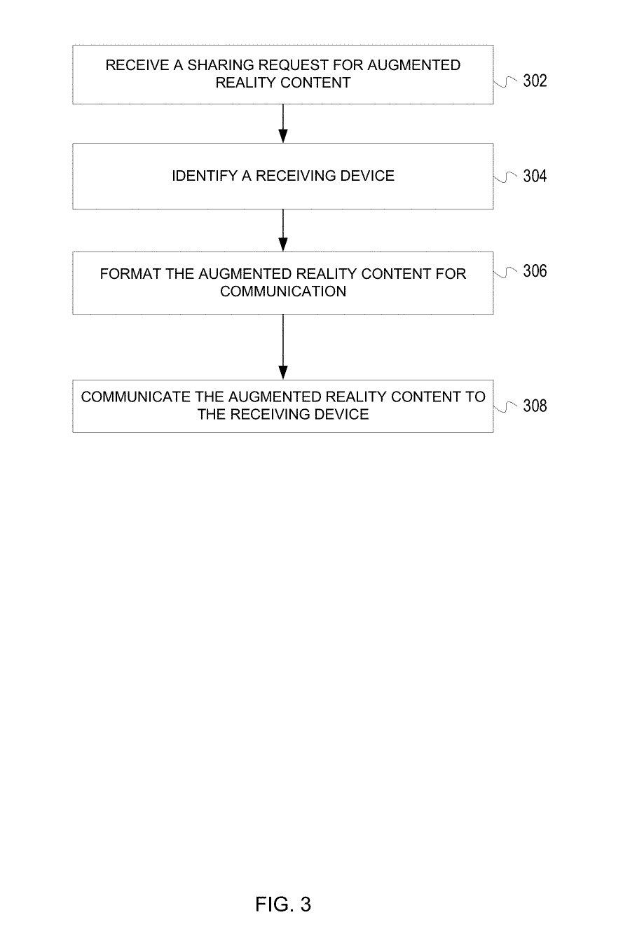

FIG. 3 is a flowchart of a process for sharing augmented reality content in accordance with an illustrative embodiment. In one embodiment, the process of FIG. 3 may be implemented by one or more wireless earpieces, such as the wireless earpieces 102 of FIG. 1. The method of FIG. 3 may be performed to communicate information by and between a first system including the wireless earpieces and an augmented reality/virtual reality headset and a second system that may be identical, similar, or distinct from the first system. The wireless earpieces may share augmented reality content which may include audio, visual, and other information, data, and graphics. The wireless earpieces may also share and synchronize the location, orientation, and position of the user to communicate accurate augmented and virtual reality content (e.g., location, position, angle, and motion of the user's head and body, etc.). In addition to communicating with other augmented and virtual reality systems, the wireless earpieces may communicate with one or more electronic devices, such as a smart case, wireless devices, computing devices, entertainment devices, medical devices, or so forth, to perform the method of FIG. 3. The wireless earpieces may be physically or wirelessly connected to the augmented reality glasses/virtual reality headset and/or associated virtual reality communications or computing system (e.g., gaming system, personal computer, cell phone, etc.). For example, the wireless earpieces may be connected by a wire interface that both powers the wireless earpieces and communicates and receives audio content from the wireless earpieces.

In one embodiment, the process may begin by receiving a sharing request for augmented reality content (step 302). The sharing request may be automatically or manually generated. In one embodiment, the wireless earpieces may utilize user preferences two automatically begin the sharing process with one or more designated devices. For example, the user preferences may specify that the wireless earpiece automatically shares the augmented reality content with a first device and a second device in response to the first and second devices being within range, available, or connected to a specified network. In another embodiment, the sharing request may be received from a user. For example, a user may provide a verbal, textual, tactile, gesture, or motion-based input that is detected by the wireless earpieces to implement a sharing process. The augmented reality content may represent instructions, communications, directions, entertainment content, business or marketing information, or other applicable information.

Next, the system identifies a receiving device (step 304). In one embodiment, the receiving device is a second system or device similar to the first system that is sharing the augmented reality content. However, the second system receiving the augmented reality content may represent any number of systems, devices, equipment, or components configured to display, play, or otherwise communicate the augmented reality content to a user. The receiving device may represent one or more secondary users communicating with the first user utilizing the sharing system. The receiving device may be identified utilizing any number of IP addresses, IMEIs, user names, hardware codes, or other device or user identifiers. The receiving device may have been previously selected by the user. The receiving device may also be identified utilizing any number of identification, pairing, or other communications processes. The receiving device may be identified utilizing any number of verbal, tactile, textual (e.g. alphanumeric), motion, or gesture inputs. For example, the user may verbally select a device, such as “Pete's phone” or nodding in a direction of a specified receiving device to associate the system with the receiving device.

Next, the system formats the augmented reality content for communication (step 306). The augmented reality content may represent audio, video, text, virtual, or other content whether integrated or not. In one embodiment, audio content may be integrated with real-life video or images to create the augmented reality content. For example, multiple types of streams, data, or information may be integrated to form the augmented reality content. The augmented reality content may represent entertainment, educational, mapping, marketing, communications, or other content frequently communicated between wireless devices.

Next, the system communicates the augmented reality content to the receiving device (step 308). The augmented reality content may be communicated through any number of wired or wireless interfaces utilized by the augmented reality system. For example, Bluetooth, Wi-Fi, cellular, or other similar signals may be utilized by the augmented reality system or individual devices, such as the wireless earpieces, augmented reality glasses, virtual reality goggles, wireless devices (e.g., smart phones, tablets, laptops, etc.). Although described as a receiving device, the receiving device may represent any number of receiving systems, equipment, components, or so forth. For example, the receiving device may represent an augmented reality system similar to the one communicating the augmented reality content. The communications of step 308 may represent ongoing real-time communications or discrete messages. In one embodiment, the receiving device may, display, or otherwise indicate that the augmented reality content is available to the receiving device. The receiving user may select whether the augmented reality content is played, displayed, or otherwise received.

As previously noted, the augmented reality content may represent any number of different types of media content may be utilized for various purposes. For example, the augmented reality content may represent historical information associated with a location of the user that may be communicated to a receiving user utilizing the receiving device. In another example, the augmented reality content may represent coupons or advertising communicated from a retailer, marketing agent, or selling party to a potential customer or interested party.

During the process of FIG. 3, the wireless earpieces may detect a position and an orientation of a head of a user. The position and the orientation of the user's head may be determined utilizing one or more accelerometers, gyroscopes, proximity sensors, optical sensors, or other sensors of the wireless earpieces or the augmented reality glasses. The wireless earpieces may also determine information based on a user selected activity or activity detected by the wireless earpieces. For example, if the user has selected a biking simulation or activity, the wireless earpieces may expect a corresponding head position and orientation. The position and orientation may include global positioning information, spatial positioning within a room or other environment, x, y, and z orientation of the user's head utilizing any number of planes or axis, distance between objects (e.g., user's head and the floor/wall, etc.). For example, the wireless earpieces may utilize a share request of nodding the head twice when the user is determined to be riding a bicycle to share the user's cadence, speed, and heart rate.

The augmented reality content may include audio content, data, information, and optical content captured by the wireless earpieces. In one embodiment, the audio content may be integrated material or content from a simulation, game, broadcast, or other media. The audio content may also be received from the user by one or more microphones of the wireless earpieces including ear-bone and external microphones to detect the voice, sounds, or other audio input from the user. The microphones may also sense content associated with the user's environment, such as other users proximate the user, organic, mechanical, or electric sounds, or so forth. As previously noted, the audio content may also be received by a transceiver of the wireless earpieces through a physical or wireless connection for processing.

As noted, the wireless earpieces may enhance the audio content utilizing the position and orientation of the user. In one embodiment, the position, orientation, and audio content received from the user (e.g. verbal commands, indicators, stimuli, etc.) may be associated with specific sharing commands or actions implemented by the wireless earpieces, the augmented reality glasses, or other computing or communications systems in communication with the wireless earpieces. For example, a combination of the position, orientation, and audio content may be stored in a database with associated sharing actions, commands, communications, scripts, applications, or processes that may be implemented or executed. The augmented reality content may also be enhanced utilizing filtering, amplification, signal processing, and other processes to remove unwanted noise, jitter, latency, or so forth.

In one embodiment, a receiving party may be required to accept the augmented reality content, once accepted, the system may immediately deliver the augmented reality content. The augmented reality content may be delivered without significant delay or latency. As a result, any potential video, pictures, or other visual content of the augmented reality content may be synchronized with the audio content captured by the wireless earpieces to prevent unwanted dizziness, disorientation, or motion sickness due to differing inputs. The immediate delivery of the augmented reality content may ensure that real-time or time sensitive applications, such as communications, gaming, simulations, or so forth are implemented without delay. The system may also be utilized to receive augmented reality content from one or more other systems.

The playback and communication of the augmented reality content may be coordinated based on user actions, conditions, position, location, or so forth. For example, specific three-dimensional noises may be played in each of the wireless earpieces corresponding to the left and right ears of the user to make the environment seem more realistic (e.g., stereo sound). Likewise, the volume and other audio effects may be varied to match the orientation of the user's head (or avatar) within an augmented reality environment. The augmented reality content may include flags, timestamps, or other information for synchronizing playback. The synchronization of the audio and visual content may ensure that the user does not become disoriented, motion sick, or otherwise adversely affected. The audio content may be delivered, played, or otherwise communicated based on synchronization information determined between the augmented reality glasses and the wireless earpieces. For example, the left and right wireless earpieces may play distinct content based on the augmented reality environment with which the user is interacting. Distinct sounds, volumes, and audio effects may be utilized by each of the wireless earpieces. As a result, the user is able to experience a unique virtual environment with corresponding sounds without significant increases in weight or other forces imposed upon the user by much larger sound systems.

Although, not specifically described, the process of FIG. 3 may begin with the wireless earpieces being linked with augmented reality glasses. In one embodiment, the user may magnetically couple the wireless earpieces with the augmented reality glasses. For example, each side of the augmented reality glasses may include a connector corresponding to the left and right wireless earpieces. The wireless earpieces may include magnetic contacts that couple the two devices to communicate data as well as provide a power connection for powering the wireless earpieces utilizing power provided by the augmented reality glasses (e.g., battery, power adapter, USB connection, etc.). As a result, the power capacity of the wireless earpieces may be increased significantly. In another embodiment, either of the wireless earpieces or the augmented reality glasses may include connectors and ports for physically connecting to one another. The two devices may also communicate utilizing an inductive connection between the wireless earpieces and the augmented reality glasses. In another embodiment, the wireless earpieces and the connectors of the augmented reality glasses may utilize short range communications, such as Bluetooth, ANT+, or other radiofrequency communications to communicate. The wireless earpieces may be integrated with her connected to connectors, extensions, arms, the frame, or other portions of the augmented reality glasses.

The wireless earpieces may also synchronize playback or communication of the audio content with visual content of the augmented reality system. As previously noted, the wireless earpieces may utilize any number of sensors to determine the location, velocity (e.g. linear, angular, etc.), position of the user (and the user's head), orientation, acceleration, biometric condition (e.g., heart rate, blood oxygenation, temperature, etc.), and other information to adjust the exact timing, volume, tuning, balance, fade, and other audio effects communicated to the user by the speakers of the wireless earpieces. The wireless earpieces may also send or receive commands for synchronizing and managing the audio content played or communicated by the wireless earpieces with associated visual content.

The illustrative embodiments provide a system, method, and wireless earpiece(s) for sharing augmented reality content. The augmented reality content may be enhanced with audio that may be captured and received through the wireless earpieces. The augmented reality content may also be enhanced and delivered with additional biometrics, information, and data captured including the location, position, orientation, motion, and acceleration of the user. The captured data and information may be utilized to more effectively deliver augmented reality content for the user as well as to interact with media content of the virtual reality or augmented reality system. The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

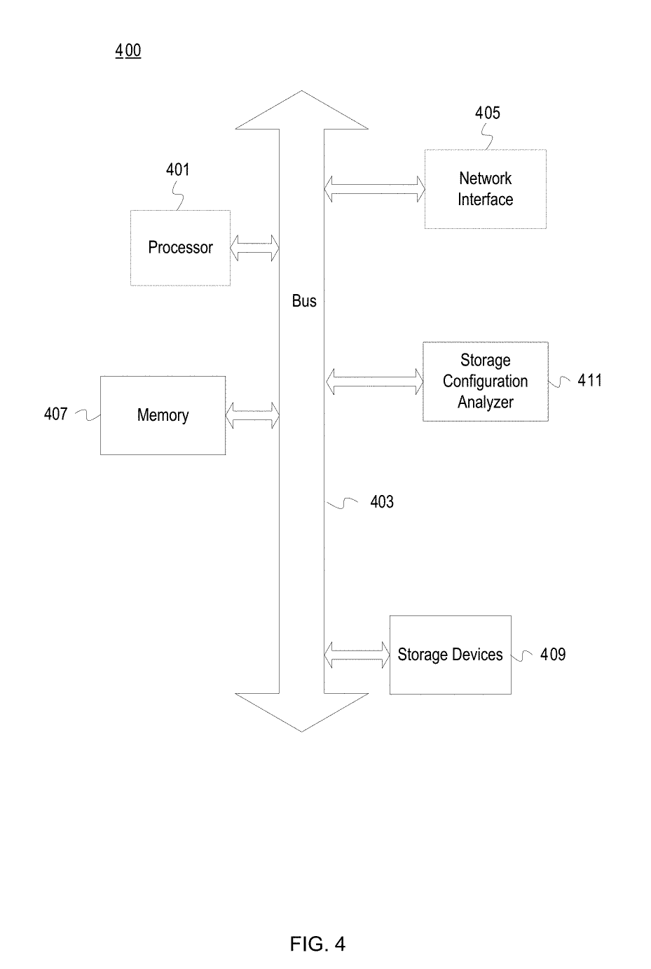

FIG. 4 depicts a computing system 400 in accordance with an illustrative embodiment. For example, the computing system 400 may represent an electronic computing or communications device, such as an augmented reality system. The augmented reality system may communicate with wireless earpieces, augmented reality glasses, sensors, or other electronics, devices, systems, equipment, or components. The computing device 400 may be utilized to receive user settings, instructions, or feedback for controlling the power management features of the wireless earpieces together and separately. The computing system 400 includes a processor unit 401 (possibly including multiple processors, multiple cores, multiple nodes, and/or implementing multi-threading, etc.). The computing system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The system memory 407 embodies functionality to implement embodiments described above. The system memory 407 may include one or more functionalities that recognize user information for communicating audio content to the wireless earpieces, augmented reality glasses, or so forth. The system memory 407 may also process audio input received from wireless earpieces, augmented reality glasses, or other devices. Code may be implemented in any of the other devices of the computing system 400. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for communicating augmented reality content, comprising:
receiving a sharing request for the augmented reality content through wireless earpieces;
identifying one or more receiving devices;
formatting the augmented reality content for communication; and
communicating the augmented reality content to the one or more receiving devices.

2. The method of claim 1, wherein the sharing request is received from a user.

3. The method of claim 1, wherein the sharing request is received automatically based on user preferences.

4. The method of claim 1, further comprising:
associating the one or more receiving devices with the wireless earpieces.

5. The method of claim 1, wherein the wireless earpieces are part of an augmented reality system.

6. The method of claim 1, wherein the augmented reality content includes at least audio content for the one or more receiving devices.

7. The method of claim 1, wherein the augmented reality content is communicated directly to the one or more receiving devices.

8. The method of claim 1, wherein the augmented reality content is communicated indirectly through one or more networks or secondary devices to the one or more receiving devices.

9. The method of claim 1, wherein the wireless earpieces are linked with augmented reality glasses to communicate the augmented reality content to a first user wearing the wireless earpieces.

10. The method of claim 9, further comprising:
perform sensor measurements from the wireless earpieces; and
communicating the sensor measurements from the wireless earpieces to the augmented reality glasses, wherein the sensor measurements include at least gyroscopes and accelerometers for determining the orientation and the position of the head of the user and audio measurements from one or more microphones of the wireless earpieces.

11. Wireless earpieces comprising:
a processor for executing a set of instructions; and
a memory for storing the set of instructions, wherein the set of instructions are executed to:
receive a sharing request for the augmented reality content through the wireless earpiece;
identify one or more receiving devices;
format the augmented reality content for communication; and
communicate the augmented reality content to the one or more receiving devices.

12. The wireless earpieces of claim 11, wherein the sharing request is received through one or more of a plurality of sensors.

13. The wireless earpieces of claim 11, wherein the sharing request is received automatically based on user preferences.

14. The wireless earpieces of claim 11, wherein the set of instructions are further executed to:
perform sensor measurements from sensors of the wireless earpieces; and
communicate the sensor measurements from the wireless earpieces to augmented reality glasses utilized by a first user wearing the wireless earpieces, wherein the sensors include at least gyroscopes and accelerometers for determining an orientation, position, motion, and acceleration of a head of the first user.

15. The wireless earpieces of claim 13, wherein the sensors include at least gyroscopes and accelerometers for determining an orientation, position, motion, and acceleration of the head of the user.

16. An augmented reality system, comprising:
augmented reality glasses displaying augmented reality content to a user;
wireless earpieces including sensors that detect a position and an orientation of a head of the user and one or more microphones, wherein the wireless earpieces receive a sharing request for the augmented reality content through wireless earpieces, identify one or more receiving devices, format the augmented reality content for communication, and communicate the augmented reality content to the one or more receiving devices.

17. The augmented reality system of claim 16, wherein the augmented reality content includes audio content to be shared with one or more other users.

18. The augmented reality system of claim 16, wherein the wireless earpieces automatically implement the sharing request in response to user preferences.

19. The augmented reality system of claim 18, wherein the one or more receiving devices represent one or more augmented reality systems.

20. The augmented reality system of claim 16, wherein at least audio content and video content are integrated to form the augmented reality content.
